(19) United States
(12) Patent Application Publication
(10) Pub. No.: US 2022/0203449 A1
(43) Pub. Date: Jun. 30, 2022

(54) METAL MEMBER, METAL COMPOSITE STRUCTURE, AND METHOD OF MANUFACTURING METAL MEMBER

(71) Applicant: SHENZHENSHI YUZHAN PRECISION TECHNOLOGY CO., LTD., Shenzhen (CN)

(72) Inventors: CHEN-YU HONG, New Taipei (TW); YI-CHUN CHEN, New Taipei (TW); ZHENG-GANG YANG, Shenzhen (CN)

(21) Appl. No.: 17/546,365

(22) Filed: Dec. 9, 2021

(30) Foreign Application Priority Data
Dec. 30, 2020 (CN) 202011613573.3

(51) Int. Cl. B22F 10/28; B22F 12/41; B22F 12/49; B33Y 10/00; B33Y 80/00; B22F 5/10

(52) U.S. Cl. CPC B22F 10/28; B22F 12/41; B22F 5/10; B33Y 10/00; B33Y 80/00; B22F 12/49

(57) ABSTRACT

A metal member includes a base and a mesh structure arranged on the base. The mesh structure includes a plurality of three-dimensional unit cell structures coupled together in an orderly manner. Each unit cell structure includes at least one first node. The plurality of unit cell structures is coupled together by the at least one first node.

### FIELD

The subject matter herein generally relates to a metal composite member, and more particularly to a metal member of the metal composite member and a method for manufacturing the metal member.

### BACKGROUND

In the production of industrial products, such as electronic products, it is usually necessary to combine metals with other materials, such as plastic. However, physical properties of metal and plastic are different, and they cannot be combined by fusion casting commonly used in the industry.

### BRIEF DESCRIPTION OF THE DRAWINGS

Implementations of the present disclosure will now be described, by way of embodiments, with reference to the attached figures.

FIG. 1 is a perspective schematic diagram of a first embodiment of a metal member.

FIG. 2 is a side view of the metal member shown in FIG. 1.

FIG. 3 is a perspective schematic view of a second embodiment of a metal member.

FIG. 4 is a side view of the metal member shown in FIG. 3.

FIG. 5 is a perspective schematic diagram of a third embodiment of a metal composite structure.

FIG. 6 is a perspective schematic diagram of a fourth embodiment of a metal composite structure.

FIG. 7 is a flowchart of a method for manufacturing a metal member of a fifth embodiment of a metal composite structure.

FIG. 8 is a flowchart of a method for manufacturing a metal composite member of a sixth embodiment of a metal composite structure.

FIG. 9 is another embodiment of a flowchart of a method for manufacturing a metal composite structure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or another word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

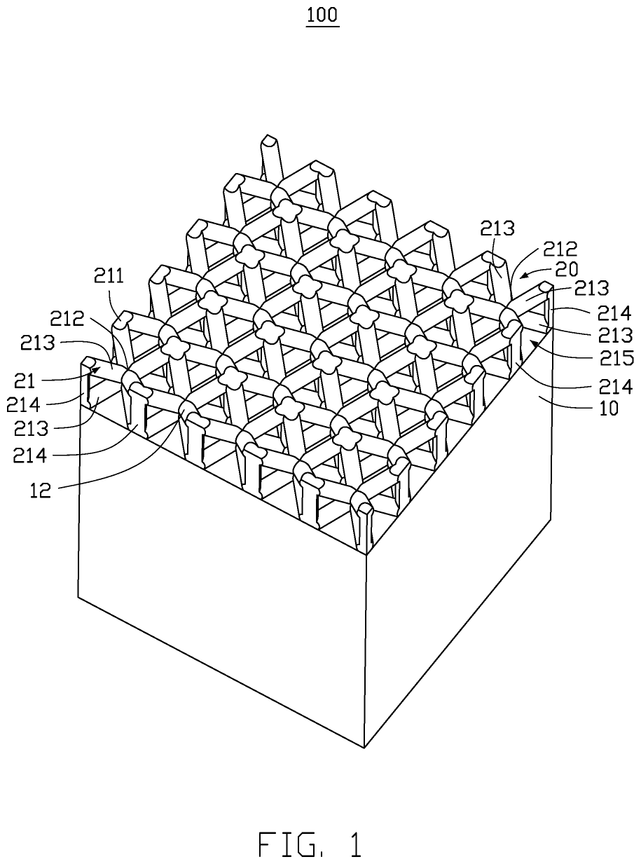

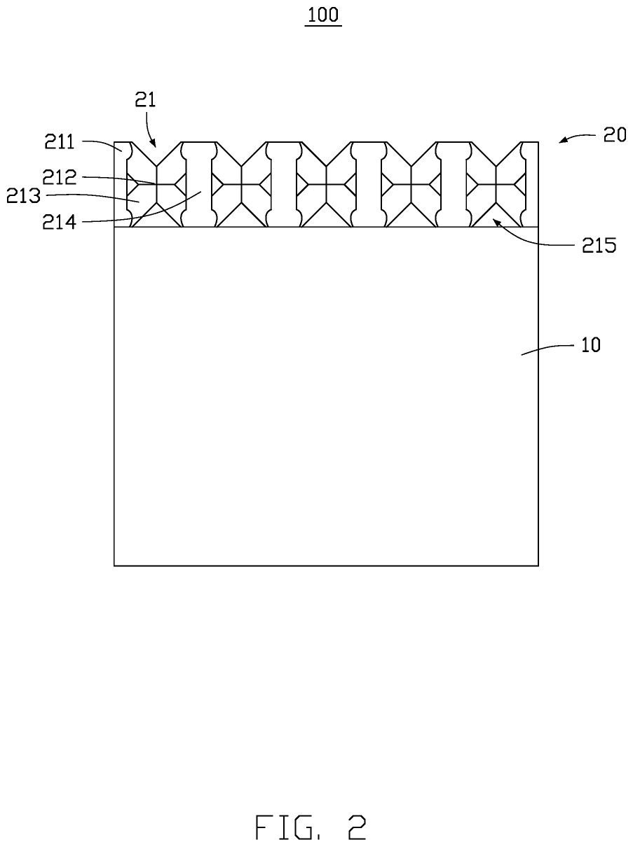

FIGS. 1 and 2 show a first embodiment of a metal member 100. The metal member 100 includes a base 10 and a mesh structure 20 arranged on the base 10. The mesh structure 20 includes a plurality of three-dimensional unit cell structures 21. The plurality of unit cell structures 21 are coupled together in an orderly manner.

The unit cell structure 21 includes at least one first node 211, and the plurality of unit cell structures 21 is coupled by the at least one first node 211.

A material of the metal member 100 may be one of stainless steel, die steel, titanium alloy, and aluminum alloy. The base 10 and the mesh structure 20 may be an integrally formed structure.

Referring to FIGS. 1 and 2, the unit cell structure 21 includes at least one second node 212. The second node 212 is coupled to the first node 211 and located inside the unit cell structure 21.

The unit cell structure 21 further includes at least one first connecting portion 213 and at least one second connecting portion 214. The first node 211 and the second node 212 are coupled together by the first connecting portion 213. The unit cell structure 21 includes a plurality of first nodes 211 and one second node 212. At least two first nodes 211 are coupled together by the second connecting portion 214. The first node 211 and the second node 212 are coupled together by the first connecting portion 213.

Specifically, in the first embodiment, each single unit cell structure 21 includes eight first nodes 211 and one second node 212. The eight first nodes 211 and one second node 212 form a body-centered cubic (BCC) crystalline structure. The eight first nodes 211 are located at vertices of the body-centered cubic structure, and the second node 212 is located at a center of the unit cell structure 21.

Further, the unit cell structure 21 is a polyhedral structure, such as a hexahedral structure. When the mesh structure 20 includes a plurality of unit cell structures 21, each polyhedral structure is coupled to at least one adjacent polyhedral structure, thereby making a plurality of orderly arranged unit cell structures 21.

The unit cell structure 21 further includes a gap 215 surrounded by a plurality of first connecting portions 213 and a second connecting portion 214, and the plurality of unit cell structures 21 are coupled in sequence to form the mesh structure 20. Further, when the plurality of unit cell structures 21 are coupled together, the gap 215 of each unit cell structure 21 communicates with the gap 215 of an adjacent unit cell structure 21. When other materials are filled in the mesh structure 20, it helps to fill the filler and to discharge the gas in the gap 215.

The unit cell structure 21 is formed between a plurality of first nodes 211 and a second node 212, and the plurality of unit cell structures 21 are coupled in sequence to form a three-dimensional isotropic structure. It should be noted that due to a defined shape of the metal member 100, due to size limitations of the isotropic unit cell structures 21, the unit cell structures 21 located at an edge of the metal member 100 may not be complete unit cell structure 21. The mesh structure 20 includes at least one complete unit cell structure 21.

In one embodiment, the first connecting portion 213 and the second connecting portion 214 are substantially rod-shaped. In other embodiments, the first connecting portion 213 and the second connecting portion 214 may also be ring-shaped or in the form of other shapes.

Further, the first connecting portion 213 and the second connecting portion 214 are formed by laser selective melting. A beam diameter of the laser is 0.3 mm, thereby forming the mesh structure 20 with a thickness of 0.1 mm. In other embodiments, the first connecting portion 213 and the second connecting portion 214 may be formed by other methods.

In one embodiment, one second connecting portion 214 and two first connecting portions 213 form a triangle structure. Further, the triangle is an equilateral triangle, and an angle between the second connecting portion 214 and the first connecting portion 213 is 60°.

In one embodiment, a porosity of the mesh structure 20 is between 40% and 80%. Specifically, the porosity refers to a ratio of a total volume of the gaps 215 to a total volume of the mesh structure 20. When the unit cell structure 21 is formed by the laser with a beam diameter of 0.3 mm, the porosity of the mesh structure 20 ranges from 50% to 65%.

When the first connecting portions 213 and the second connecting portions 214 in the unit cell structure 21 are formed by a laser with a beam diameter of 0.25 mm, the porosity of the mesh structure 20 ranges from 65% to 75%.

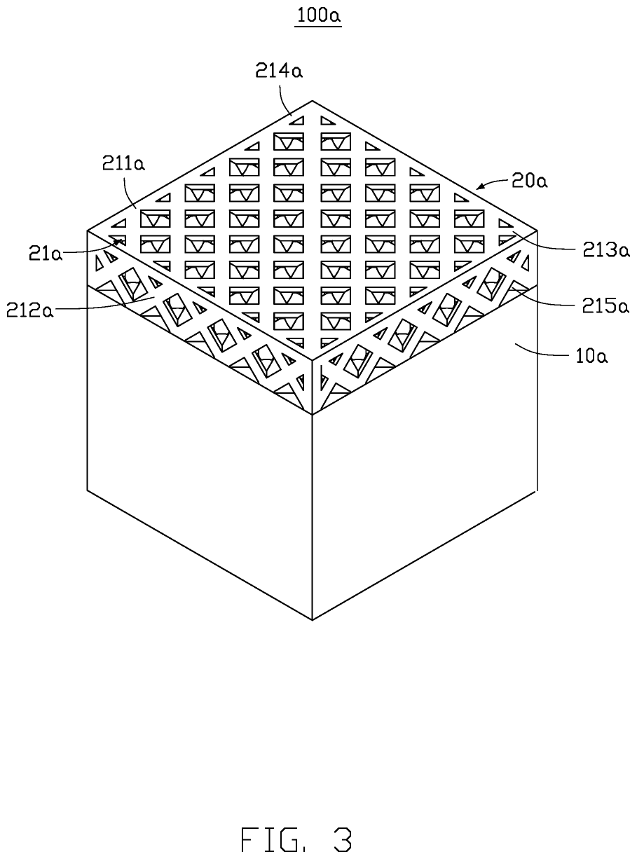

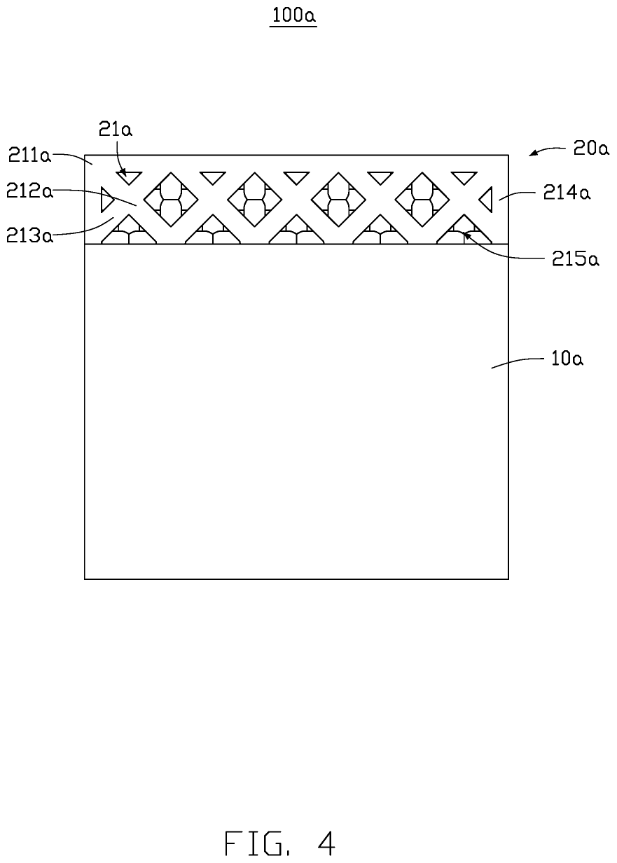

FIGS. 3 and 4 show a second embodiment of a metal member 100a. The metal member 100a includes a base 10a and a mesh structure 20a arranged on the base 10a. The mesh structure 20a includes a plurality of three-dimensional unit cell structures 21a, and the plurality of unit cell structures 21a are coupled together in an orderly manner. The unit cell structure 2a1 includes at least one first node 211a, and the plurality of unit cell structures 21a are coupled together by the at least one first node 211a.

A material of the metal member 100a may be one of stainless steel, die steel, titanium alloy, and aluminum alloy. The base 10a and the mesh structure 20a may be an integrally formed structure. The unit cell structure 21a includes at least one second node 212a. The second node 212a is coupled to the first node 211a and located at a surface center (face center) of the unit cell structure 21a. The unit cell structure 21a further includes at least one first connecting portion 213a and at least one second connecting portion 214a. The first nodes 211a and the second nodes 212a are coupled together by the first connecting portion 213a. In one embodiment, each unit cell structure 21a includes a plurality of first nodes 211a and one second node 212a. At least two first nodes 211a are coupled together by the second connecting portion 214a. The first nodes 211a and the second node 212a are coupled together by the first connecting portion 213a.

Specifically, each unit cell structure 21a includes eight first nodes 211a and six second nodes 212a. The eight first nodes 211a and six second nodes 212a form a face-centered cubic (FCC) crystalline structure. The eight first nodes 211a are located at vertices of the face-centered cubic structure, and the six second nodes 212a are located at face centers of the face-centered cubic structure.

In one embodiment, one second connecting portion 214a and two first connecting portions 213a form a triangle structure. Further, the triangle is an equilateral triangle, and an angle between the second connecting portion 214a and the first connecting portion 213a is 60°.

In the second embodiment, when the unit cell structures 21a are formed by a laser with a beam diameter of 0.3 mm, the porosity of the mesh structure 20a ranges from 50% to 65%.

When the unit cell structures 21a are formed by a laser beam with a beam diameter of 0.25 mm, the porosity of the mesh structure 20a ranges from 65% to 72%.

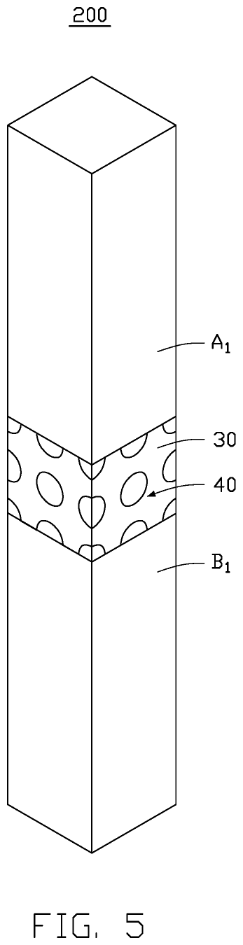

Referring to FIG. 1, FIG. 2, and FIG. 5, in a third embodiment, a metal composite structure 200 is provided. The metal composite structure 200 can be applied to electronic devices. The metal composite structure 200 includes the metal member 100 and a filler 30. The metal member 100 includes a first metal member A1. The first metal member A1 includes the mesh structure 20. The gaps 215 are defined in the unit cell structures 21 of the mesh structure 20, and the filler 30 is formed in the gaps 215.

In one embodiment, the metal member 100 further includes a second metal member B1. Similarly, the second metal member B1 includes the mesh structure 20, the gaps 215 defined in the unit cell structures 21 of the mesh structure 20, and the filler 30 formed in the gaps 215 of the second metal member B1.

Each of the first metal member A1 and the second metal member B1 includes the base 10 and the mesh structure 20 arranged on the base 10. The mesh structure 20 includes the plurality of unit cell structures 21 coupled together in an orderly manner. Each unit cell structure 21 includes at least one first node 211, and the plurality of unit cell structures 21 are coupled together by the at least one first node 211.

The first metal member A1 and the second metal member B1 may be the metal member 100 composed of the unit cell structures 100 having the body-centered cubic (BCC) crystalline structures as described in the first embodiment.

In one embodiment, a structure of the second metal member B1 is the same as or similar to the structure of the first metal member A1.

The first metal member A1 and the second metal member B1 correspond to ends of the mesh structure 20, and the filler 30 is filled in the gaps 215 of the first metal member A1 and in the gaps 215 of the second metal member B1. The filler 30 filled in the gaps 215 of the first metal member A1 is continuous with the filler 30 filled in the gaps of the second metal member B1, so that the first metal member A1 and the second metal member B1 are bonded together.

The first metal member A1, the second metal member B1, and the filler 30 form a bonding area 40. The bonding area 40 is the filler 30 filled in the gaps 215 of the mesh structures 20 of the first metal member A1 and the second metal member B1.

In summary, the gaps 215 in each unit cell structure 21 are filled by the filler 30. The filler 30 in each gap 215 is uniform, the filler 30 can be filled in the gaps 215, which improves the bonding strength of the metal composite structure 200 in the bonding area 40, and the bonding force between the first metal member A1 and the second metal member B1 is increased.

Furthermore, the three-dimensional ordered structure formed by the unit cell structures 21 is isotropic, and the filler 30 filled in the gaps 215 are also isotropic. In this way, the first metal member A1, the second metal member B1, and the filler 30 in the bonding area 40 form an interlocking structure, which is beneficial for improving a bonding force therebetween.

A material of the filler 30 may be at least one of metal, plastic, ceramic, and glass. The filler 30 is filled in the gaps 215 in the mesh structure 20 in the manner of a filling liquid. The filling liquid may be at least one of molten metal, injection molding liquid, ceramic liquid, and molten glass.

FIG. 5 shows the first metal member A1 and the second metal member B1 in the shape of a regular cuboid structure. In other embodiments, the first metal member A1 and the second metal member B1 may also have irregular shapes, and the base 10 of the first metal member A1 and the base 10a of the second metal member B1 may be different.

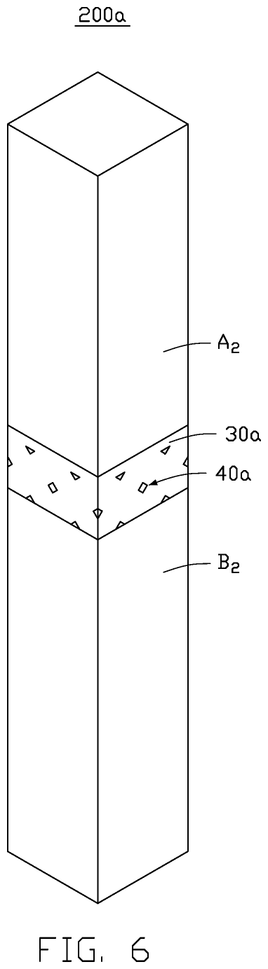

Referring to FIGS. 3, 4, and 6, in a fourth embodiment, a metal composite structure 200a is provided. The metal composite structure 200a is substantially the same as the metal composite structure 200 of the third embodiment. In the fourth embodiment, the first metal composite structure 200a includes a first metal member A2 and a second metal member B2 having the mesh structure 20a composed of the unit cell structures 21a having the face-centered cubic (FCC) crystalline structure as descried in the second embodiment.

The metal composite structure 200a provided in the fourth embodiment and the metal composite structure 200 provided in the third embodiment achieve substantially similar effects, which will not be repeated here.

The metal composite structures 200 and 200a provided in the third embodiment and the fourth embodiment can withstand a pulling force of at least 25 megapascals (Mpa). In the third embodiment, a minimum pulling force that the metal composite structure 200 can withstand is 68.2 Mpa, and a maximum pulling force that the metal composite structure 200 can withstand is 73.1 Mpa. In the fourth embodiment, a minimum pulling force that the metal composite structure 200a can withstand is 50.9 Mpa, and a maximum pulling force that the metal composite structure 200a can withstand is 68.3 Mpa.

A pulling force test involves applying the same pulling force to each end of the metal composite structures 200, 200a in opposite directions. The above-mentioned pulling force of at least 25 Mpa means that when a force of at least 25 Mpa is applied to each end of the metal composite structures 200, 200a, the structure of the metal composite structures 200, 200a will not be affected by cracking, breaking, or otherwise deformed.

Table 1 below shows a comparison of performance between the metal composite structures 200, 200a formed by lasers having different beam diameters.

TABLE 1

| | Metal composite | | Metal composite | |
|---|---|---|---|---|
| | structure 200 | | structure 200a | |
| Laser beam diameter | 0.3 mm | 0.25 mm | 0.3 mm | 0.25 mm |
| Crystalline structure of | BCC | BCC | FCC | FCC |
| unit cell structure | structure | structure | structure | structure |
| Porosity | 61% | 71% | 61% | 72% |
| Average pulling force | 70.6 | 73.1 | 68.3 | 53.5 |
| tolerance (Mpa) | | | | |
| Maximum pulling force | 71.9 | 74.5 | 69.6 | 56.5 |
| tolerance (Mpa) | | | | |
| Minimum pulling force | 68.2 | 71.4 | 66.8 | 50.9 |
| tolerance (Mpa) | | | | |

As shown in Table 1, each of the metal composite structures 200, 200a formed by lasers having different beam diameters can withstand a relatively large pulling force. It can be understood that the beam diameter of the laser is inversely proportional to the porosity.

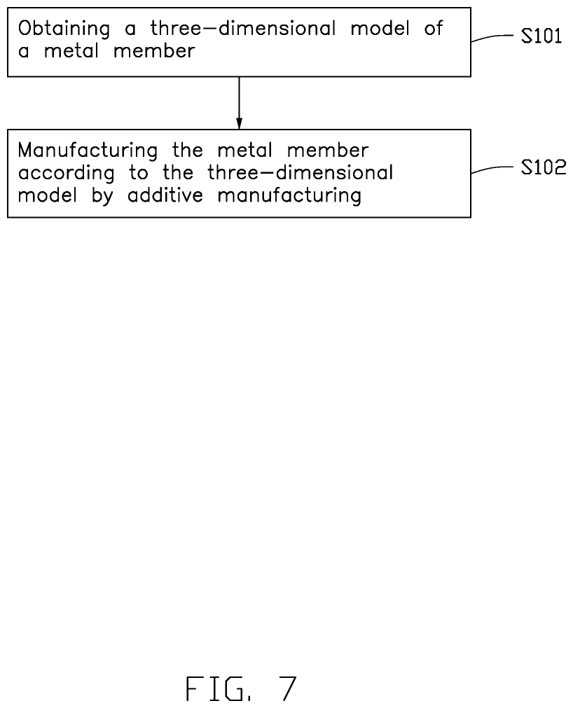

FIG. 7 shows a fifth embodiment of a method for manufacturing a metal member. The method may be an additive manufacturing method executed by an additive manufacturing system. The method includes the following blocks.

At block S101, a three-dimensional model of a metal member is obtained.

Before the metal member is manufactured, a three-dimensional model of the metal member in the additive manufacturing system is created in advance, and the three-dimensional model corresponds to a physical structure of the metal member actually produced by additive manufacturing.

At block S102, the metal member is manufactured according to the three-dimensional model by additive manufacturing.

The metal member includes a substrate and a mesh structure arranged on the substrate. The mesh structure includes a plurality of unit cell structures, and the plurality of the unit cell structures is coupled together in an orderly manner. The unit cell structure includes at least one first node, and the plurality of unit cell structures is coupled together by the at least one first node.

The additive manufacturing method is selected from one of electron beam forming, laser near net forming, laser selective melting, and laser selective sintering.

A material of the metal member is selected from at least one of stainless steel, die steel, titanium alloy, and aluminum alloy.

In one embodiment, the material for preparing the metal member is in the form of metal powder, and a particle size of the metal powder is between 10 μm and 50

In one embodiment, the method of additive manufacturing is laser selective melting, and a diameter of the laser beam is between 0.15 mm and 0.4 mm. In other embodiments, the laser beam diameter can be changed according to the difference of the metal member 100. A power of the laser is in the range of 160 W to 220 W, a scanning speed of the laser is in the range of 900 mm/s to 1400 mm/s, and a scanning pitch of the laser is in the range of 0.04 mm to 0.1 mm.

The method for manufacturing the metal member is an additive manufacturing method, so that a structure, a size distribution, and other characteristics of the unit cell structures can be configured as required, and then the plurality of unit cell structures are formed into the mesh structure. In addition, a preparation method of the metal member does not use chemical reagents, and the materials of the metal member are not limited, which can save costs and reduce environmental pollution.

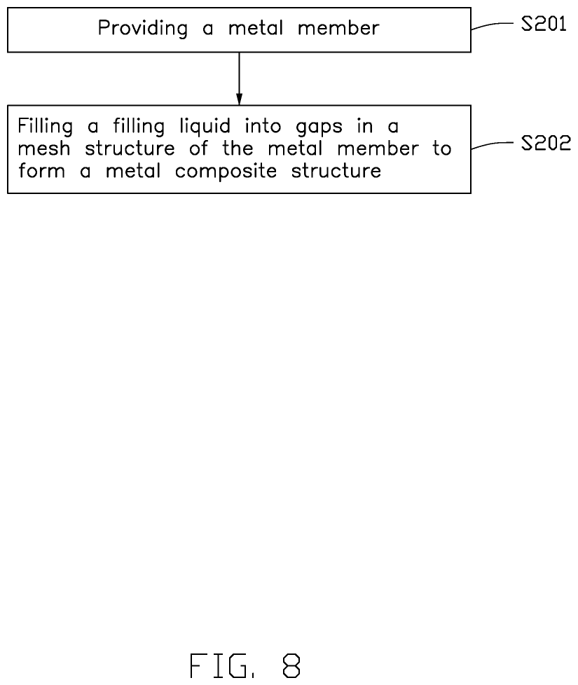

FIG. 8, shows a sixth embodiment of a method for manufacturing a metal composite structure. The method includes the following blocks.

At block S201, a metal member is provided. The metal member includes a base and a mesh structure arranged on the base. The mesh structure includes gaps and a plurality of unit cell structures. The plurality of unit cell structures are coupled together in an orderly manner. The unit cell structure includes at least one first node, and a plurality of the unit cell structures are coupled together by the at least one first node.

The metal member may be obtained by additive manufacturing, such as 3D printing technology. In other embodiments, the metal member may be obtained by other methods.

At block S202, a filling liquid is filled into the gaps in the mesh structure to form a metal composite structure.

A material of the filling liquid can be one or more of metal, polymer, ceramic, and glass. After the filling liquid is filled in the gaps and after heating, the filling liquid forms a solid filler, thereby filling the gaps to form the metal composite structure.

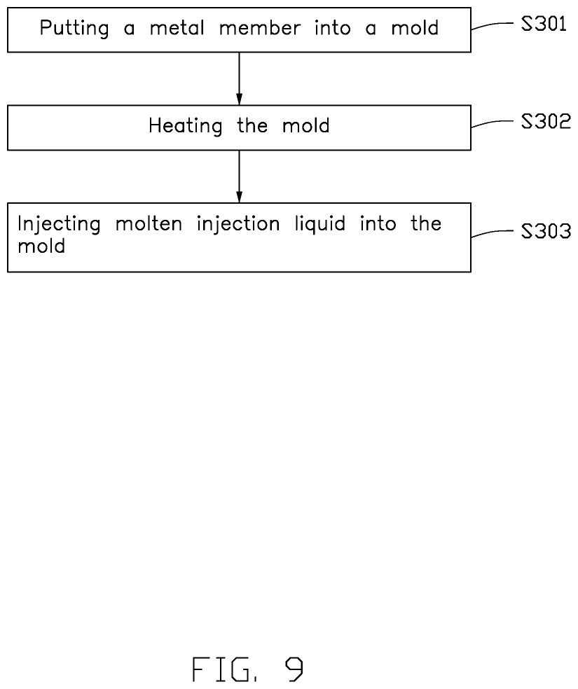

FIG. 9 shows an embodiment of a method for manufacturing the metal composite structure when the filling liquid is an injection molding liquid. The method includes the following blocks.

At block S301, the metal member is put into a mold.

At block S302, the mold is heated.

At block S303, molten injection liquid is injected into the mold.

The molten injection liquid enters the gaps of the unit cell structures and is integrated with the metal member after cooling.

A shaping method of the filling liquid can be set according to the material and state of the filling liquid. For example, when the filling liquid is made of metal and is in powder form, it can be shaped by laser melting and forming. When the filling liquid is an injection molding liquid, the shaping can be achieved by injection molding. When gas is used as a filling medium, the gas can be shaped by in-situ polymerization.

When the filler is made of powdered glass, it can be shaped by heating and melting and then cooling and shaping. When the glass is in a molten state, it can be processed by cooling and shaping.

In summary, a metal member and a manufacturing method thereof and a metal composite structure and a manufacturing method thereof are provided. The metal member is provided with a mesh structure arranged on a base, and the mesh structure includes a plurality of unit cell structures coupled together in an orderly manner, so that a structure of the metal member is more compact, and a bonding force of the metal member is improved.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A metal member comprising:
a base; and
a mesh structure arranged on the base, the mesh structure comprising a plurality of unit cell structures coupled together in an orderly manner; wherein:
each of the unit cell structures is a three-dimensional structure;
each of the unit cell structures comprises at least one first node; and
the plurality of unit cell structures are coupled together by the at least one first node.

2. The metal member of claim 1, wherein:
each of the unit cell structures further comprises at least one second node coupled to the at least one first node; and
the second node is located inside or on a surface of the corresponding one of the unit cell structures.

3. The metal member of claim 2, wherein:
the at least one first node is located at a vertex of the corresponding one of the unit cell structures; and
the at least one second node is located at a body center or a face center of the corresponding one of the unit cell structures.

4. The metal member of claim 2, wherein:
the plurality of unit cell structures further comprises a plurality of first connecting portions and a plurality of second connecting portions; and
at least one second node and the at least one first node are coupled together through the first connecting portions; and
at least two first nodes are coupled together by the second connecting portion, the at least one first node is located at vertices of the unit cell structures, and the at least one second node is located at face centers of the unit cell structures.

5. The metal member of claim 1, wherein:
each of the plurality of unit cell structures is a polyhedral structure; and
each of the unit cell structures is coupled to at least one adjacent of the unit cell structures.

6. The metal member of claim 1, wherein a thickness of the mesh structure is between 0.3 mm and 3 mm.

7. The metal member of claim 1, wherein a porosity of the mesh structure is between 40% and 80%.

8. The metal member of claim 1, wherein the base body and the mesh structure are integrally formed.

9. A metal composite structure comprising:
a metal member comprising a first metal member, the first metal member comprising a mesh structure arranged on a base, the mesh structure comprising a plurality of unit cell structures and defining a plurality of gaps in the unit cell structures, the plurality of unit cell structures being coupled together in an orderly manner; and
a filler formed in the plurality of gaps; wherein:
each of the plurality of unit cell structures is a three-dimensional structure;
each of the plurality of unit cell structures comprises at least one first node; and
the plurality of unit cell structures is coupled together by the at least one first node.

10. The metal composite structure of claim 9, wherein:
the metal member further comprises a second metal member;
the filler is formed in the plurality of gap in the mesh structure of the first metal member and in the mesh structure of the second metal member; and
the first metal member and the second metal member are bonded together by the filler.

11. The metal composite structure of claim 10, wherein a pulling force tolerance of the metal composite structure is at least 25 MPa.

12. The metal composite structure of claim 11, wherein:
each of the unit cell structures further comprises at least one second node coupled to the at least one first node; and
the second node is located inside or on a surface of a corresponding one of the unit cell structures.

13. The metal composite structure of claim 12, wherein:
the at least one first node is located at a vertex of the corresponding one of the unit cell structures; and
the at least one second node is located at a body center or a face center of the corresponding one of the unit cell structures.

14. The metal composite structure of claim 12, wherein:
The plurality of unit cell structures further comprises a plurality of first connecting portions; and
the at least one second node and the at least one first node are coupled together through the first connecting portions.

15. A method for manufacturing a metal member, the method comprising:
obtaining a three-dimensional model of the metal member; and
manufacturing the metal member according to the three-dimensional model by additive manufacturing.

16. The method for manufacturing a metal member of claim 15, wherein:
the method of additive manufacturing is a laser selective melting method;
a diameter of a laser beam of a laser in the laser selective melting method is between 0.15 mm and 0.4 mm.

17. The method for manufacturing a metal member of claim 16, wherein:
a scanning speed of the laser is in the range of 900 mm/s to 1400 mm/s; and
a scanning pitch of the laser is in the range of 0.04 mm to 0.1 mm.
